(19) United States
(12) Patent Application Publication
(10) Pub. No.: US 2007/0013140 A1
(43) Pub. Date: Jan. 18, 2007

(54) COMPOSITE FUEL PERMEATION BARRIER SEAL

(76) Inventors: Edwin J. Kent, Goshen, IN (US); Darron G. Peddle, Greenville, NC (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/533,553

(22) Filed: Sep. 20, 2006

Related U.S. Application Data
(62) Division of application No. 10/486,746, filed on Jul. 19, 2004.
(60) Provisional application No. 60/312,837, filed on Aug. 16, 2001.

(51) Int. Cl. F16J 15/02

(52) U.S. Cl. 277/312

(57) ABSTRACT

In general this invention relates to a composite seal or gasket for inhibiting the release of a volatile organic compound such as fuel. The composite seal assemblies (10, 70, 100, 130, 160, 180 and 200) include a deformable portion interconnected to a vapor barrier portion via a mechanical or adhesive interlocking connection. The deformable portion can be formed from an elastomeric material. The vapor barrier portion can be formed from a wide variety of materials that inhibit permeation of the organic vapor. Examples of the materials for the vapor barrier include ductile metals, plastic polymers, and fluoroplastic polymers. The gaskets and seals can, but are not restricted to, be used between the connections of the components in an automotive or consumer product fuel system.

### BACKGROUND OF THE INVENTION

In general this invention relates to seals and/or gaskets. More specifically, the present invention is directed to seals or gaskets for use with and between components to contain, store, and deliver volatile organic compounds, such as hydrocarbon-based fuels.

There is an increased public awareness of the environmental harm associated with the release and/or emission of volatile organic compounds such as fuel into the atmosphere. For example, recent studies have expressed concern over the potential emission of fuel vapor from automobiles. The increased number of vehicles in use has heightened this concern. While current technology effectively seals the fuel system components from liquid fuel leaks, fuel is suspected to permeate through certain seals/gaskets, albeit in minute amounts. While the actual quantity of fuel emitted per vehicle at any one time may be small, the large number of vehicles in use and the continuous emission of fuel vapor from the seals/gaskets over the lifetime of the vehicle suggests that this may measurably impact the environment. Additionally, federal regulations have been enacted mandating a reduction of airborne hydrocarbon emissions allowed per vehicle. A reduction in the fuel permeation will help automobile manufacturers meet the new federal emission standards and can enhance the quality of the environment.

In light of the above-described problems, there is a continuing need for advancements in the relevant fields, including improved containment of volatile organic compounds, reduction of fuel emission, improved seal and gasket designs, and improved methods of reducing fuel permeation through seals and gaskets, to name just a few examples. The present invention includes advancements in the relative fields and provides a wide variety of benefits and advantages.

### SUMMARY OF THE INVENTION

The present invention relates to composite seal assemblies and the manufacture and use of the seal assemblies in fuel storage and delivery systems. Various aspects of the invention are novel, nonobvious, and provide various advantages. Specific examples of certain forms and features, which are characteristic of the preferred embodiments disclosed herein, are described briefly as follows.

One form of the present invention provides a novel seal assembly. The seal assembly is adapted to be positioned between two opposing sealing members of selected components which, when joined together, can contain or convey an organic compound. In preferred embodiments, the seal assembly comprises the first sealing portion or member formed from an elastomeric material. The first member is adapted to bear against at least one and preferably both of the opposing sealing surfaces. The seal assembly also comprises a second sealing portion or member, secured to the first sealing portion and adapted to bear against at least one of the opposing sealing members. The second sealing portion can be formed of a fuel permeation-resistant material. Preferably the first and second sealing portions are connected via a mechanical interlock connection to provide the seal assembly or composite. In selected embodiments, the first and second sealing portions also can be over-laminated and/or bonded together with adhesive or a tie member. In preferred embodiments, the seal assembly significantly reduces emission of volatile organic compounds (VOCs).

The seal assembly is compressible and, when positioned between the sealing members, can deform as the system components are connected together. The second portion can be formed of a compression limiting material. Consequently, the second portion of the seal assembly can limit the deformation of the seal assembly between the sealing members and/or minimize vapor and liquid passage around the permeation-resistant portion.

In preferred embodiments, the seal assembly is adapted to be positioned between first and second surfaces that are substantially static surfaces with respect to each other. Additionally, at least one sealing surface can have a recess formed therein for receiving a portion of the seal assembly. Either the first portion, the second portion, or both first and second portions can be seated in the recess. In other embodiments, the first and/or second sealing portion(s) include beads and/or grooves which bear against the first and/or second sealing surfaces. The opposing sealing members can deform the beads and/or grooves as the system components are connected or joined together.

In one form, the present invention includes a seal assembly for providing a organic vapor permeation-resistant seal between opposing first and second sealing surfaces. The seal assembly comprises a first sealing member formed of an elastomeric material adapted to bear against the opposing first and second sealing surfaces, and a second sealing member positioned radially externally of the first sealing member and formed of a material selected to resist organic vapor permeation and sized to limit compression of the first sealing portion, wherein the first and second sealing portions are joined with a mechanical interlocking connection.

In form, the present invention provides a seal assembly that comprises a first sealing member adapted to bear against two static surfaces. The first sealing member comprises a first sealing surface including a first convex bead and an opposite second convex bead. The first sealing member can be formed of an elastomeric material. The second sealing member is formed of a material selected to resist permeation of an organic vapor and is substantially encased within said first sealing member and positioned therein radially external of the first and second beads.

In yet another form, the present invention provides a seal assembly that comprises a first sealing member that includes: a first sealing surface having a first convex bead and an opposite second sealing surface axially displaced from the first sealing surface and having a second convex bead; a second sealing member that includes a third sealing surface having a third convex bead and an opposite fourth sealing surface axially displaced from the second sealing surface and having a fourth bead wherein the first sealing member is formed of an elastomeric material, and; a third sealing member positioned between the first and second sealing members wherein the third sealing member is formed of a material selected to resist permeation of an organic vapor.

In still yet another form, the present invention provides a seal assembly comprising a first sealing member having a first sealing surface including a first convex bead; a second sealing member having a second sealing surface including a second convex bead; and a third sealing member having a first bearing surface and an opposite bearing surface, wherein the first and second bearing surfaces are substantially planar and parallel with each other and are displaced axially from each other a distance selected to limit deformation of the first and second sealing members.

In other forms, the present invention provides a method for reducing emission of volatile organic compounds. The method includes providing an organic vapor permeation barrier interconnected with a first sealing portion formed of an elastomeric material. In preferred embodiments, the fuel vapor permeation barrier is formed of a compression-limiting material. In other embodiments, the fuel vapor barrier is formed of metallic material or a fluorocarbon resin. In preferred embodiments, the permeation barrier is adapted to reduce and/or eliminate fuel permeation through the seal assembly.

Further objects, features, aspects, forms, advantages, and benefits shall become apparent from the description and drawings contained herein.

### BRIEF DESCRIPTION OF THE DRAWINGS

FIG. 1 is a top plan view of a first embodiment of a double bead seal assembly in accordance with the present invention.

FIG. 2 is a cross-sectional view of the seal assembly of FIG. 1 taken along section line 2-2.

FIG. 3 is a top plan view of one embodiment of a single bead seal assembly in accordance with the present invention.

FIG. 4 is a cross-sectional view of the seal assembly illustrated in FIG. 3 taken along section line 4-4. FIG. 5 is cross-sectional view of an alternative embodiment of a seal assembly having sealing ridges on the compression-limiting component in accordance with the present invention.

FIG. 6 is a cross-sectional view of a fuel seal assembly having a vapor permeation barrier component embedded within an elastomeric material in accordance with the present invention.

FIG. 7 is a cross-sectional view of an alternative embodiment of a double beaded seal assembly having an embedded vapor permeation barrier component in accordance with the present invention.

FIG. 8 is an alternative embodiment of an “H-shaped” seal assembly having a partially embedded vapor permeation barrier component provided in accordance with the present invention.

FIG. 9 is one embodiment of a seal assembly having an “I-shaped” vapor permeation barrier component provided in accordance with the present invention.

FIG. 10 is alternative embodiment of a seal assembly seated within a recess formed in one of the opposing sealing members in accordance with the present invention.

### DETAILED DESCRIPTION OF THE INVENTION

For the purposes of promoting and understanding the principles of the invention, reference will now be made to the embodiments illustrated herein, and specific language will be used to describe the same. It will nevertheless be understood that no limitation of the scope of the invention is thereby intended. Any alterations and further modifications in the described seals assemblies, devices, and/or methods, and any further applications of the principles of the invention as described herein, are contemplated as would normally occur to one skilled in the art to which the invention relates.

In general, the present invention provides a seal assembly that includes at least two barriers or sealing portions. The two sealing portions are connected together to form a composite seal or seal assembly. One or both of the sealing portions bear against the opposing sealing members of containment or delivery system components. In preferred embodiments, the first sealing portion can inhibit or limit liquid organic compositions from escaping. The second sealing portion inhibits organic vapor emission through and around the seal assembly. Further, one of the sealing portions provides a compressible seal component, while the second portion can limit compression or deformation of the seal assembly in use.

The seal assemblies for use in the present invention are useful as seals or gaskets between static components to limit or eliminate escape of organic chemicals. While not to limit the invention, the seals find particular advantages used to limit escape of fuel. The term “fuel” as used in the present application includes within its scope any volatile and/or combustible organic material including but not restricted to gasoline, diesel, kerosene, and the like.

Emission of volatile organic vapor is vastly different from the leaks associated with liquids such as fuel and/or liquid lubricants and oils. Vapor permeation is more insidious than liquid leakage and is both harder to detect and harder to prevent. Liquid fuel leaks may be contained using traditional elastomer seals. Organic vapor permeation, however, occurs as the organic molecules diffuse through a barrier material in the fuel system and escape to the atmosphere. Seals formed only of elastomers typically permit diffusion tens to thousands of times greater than seals formed to include metals and plastics used in fuel systems. It is this hydrocarbon diffusion or permeation that is targeted by CARB and EPA legislation that is scheduled to go into effect in Model Year 2004.

In a preferred embodiment, the present invention includes a seal assembly of two or more members formed of different materials. The first sealing portion is elastomeric and can readily deform under pressure. The amount and/or extent of deformation and the direction of the deformation can vary widely depending upon many factors, including the contour of the sealing portion, the contour of the surfaces exerting the pressure, the composition of the sealing portion, and the presence of any retaining members in or about the sealing portion and configuration of the seal assembly. Compression or deformation of the first member between two components, such as two halves of a fuel tank assembly or a fuel tank or exit tube, inhibits liquid release even under pressure. In preferred embodiments, the lower limit of the linear deformation for the sealing portion is at least about 10%; more preferably at least about 15%. Also in preferred embodiments, the upper limit for the linear deformation is less than about 35%. More preferably, the linear deformation is between about 15% and about 30%.

Typically the first sealing member is a compliant member and can include an elastomeric material. Non-limiting examples of elastomeric materials for use in the present invention include, but are not restricted to: natural rubber, synthetic polyisoprene rubber (IR), epoxylated natural rubber, styrene-butadiene rubber (SBR), polybutadiene rubber (BR), nitrile-butadiene rubber (NBR), hydrogenated NBR, hydrogenated SBR, and other diene rubbers and their hydrogenated derivatives; ethylene propylene rubber (EPDM, EPM), maleic acid-modified ethylene propylene rubber (M-EPM), butyl rubber (IIR), anisobutylene and aromatic vinyl or diene monomer copolymers, acryl rubbers (ACM), ionomers, halogon-containing rubbers (Br-IIR, Cl-IIR), a bromide of isobutylene p-methylstyrene copolymer (Br-IPMS), chloroprene rubber (CR), hydrin rubbers (CHC, CHR), chlorosulfonated polyethylene (CSM), chlorinated polyethylene (CM), maleic acid-modified chlorinated polyethylene (M-CM), and other olefin rubbers; methylvinylsilicone rubber, dimethylsilicone rubber, methylphenylvinylsilicone rubber, and other silicone rubbers; polysulfide rubber and other sulfur-containing rubbers; vinylidene fluoride rubbers, fluorine-containing vinyl ether rubbers, tetrafluoroethylene-propylene rubbers, fluorine-containing silicone rubbers, fluorine-containing phosphagen rubbers, and other fluororubbers; styrene elastomers, olefin elastomers, polyester elastomers, urethane elastomers, polyamide elastomers and mixtures and blends thereof.

The seal assembly also includes a second sealing member. In preferred embodiments, the second sealing member inhibits or retards vapor permeation, significantly reducing the permeation of organic vapors through the seal assembly. This inhibition of organic vapor permeation can be evaluated according to various test procedures. One example of a suitable procedure for use in the present invention is described in ASTM D814-95 Standard Test Method for Rubber Property-Vapor Transmission of Volatile Liquids.

The organic vapor permeation barrier can be formed by a wide variety of materials. Preferred examples include various materials including ductile metals (e.g. steel, stainless steel, aluminum, copper and brass); as well as thermoplastic polymeric materials such as poly(phenylene sulfide) (PPS); polyamides (PA), for example nylons; polysulfone (PSU); poly(ether sulfone) (PES); poly(ether imide) (PEI); polyether ether ketones (PEEK); polyamide-imide (PAI); polyimide (PI); and fluorocarbon resins such as fluorothermoplastics. Examples of fluorocarbon resins for use in the permeation barriers of the present invention include, but are not restricted to: fluorinated ethylene propylene, copolymer (FEP), copolymers of tetrafluoroethylene and perfluoro(propylvinyl ether) (PFA), homopolymers of polychlorotrifluoroethylene (PCTFE) and its copolymers with tetrafluoroethylene (TFE) or vinylidene fluoride (VF2), ethylene-chlorotrifluoroethylene copolymer (ECTFE), ethylene-tetrafluoroethylene copolymer (ETE), polyvinylidene fluoride (PVDF), and polyvinylfluoride (PVF), polytetrafluoroethylene (PTFE), hexafluoropropylene-vinylidene fluoride, vinylidene fluoride-hexafluoropropylene-tetrafluoroethylene, tetrafluoroethylene-hexafluoropropylene-vinylidene fluoride and mixtures and blends thereof.

Preferred materials are substantially inert in nature under the conditions in use and therefore exhibit resistance to degradation from many chemicals. Specific examples of the fluorocarbon resins are commercially available; for example, hexafluoropropylene-vinylidene fluoride fluoroelastomer, vinylidene fluoride-hexafluoropropylene-tetrafluoroethylene fluoroelastomer, and tetrafluoroethylene-hexafluoropropylene-vinylidene fluoride fluoroplastic terpolymer are useful in the present invention as received from commercial sources.

The second member defining the organic vapor permeation barrier is interconnected to the first portion of the seal assembly, preferably with a mechanical interlocking connection. The mechanical interlocking connection can allow the different members of the seal assembly to deform or not, independently of each other. This can reduce the internal stress on the seal assembly that could cause the two (or more) members to separate. The mechanical interlocking connection can include a wide variety of features and structures. These features can include tabs, splines, pins, teeth, projections, recesses, indents, rabbits, grooves, bores and the like. Additionally or in the alternative, the second member can be partially or completely embedded within the first member. In other embodiments, the second member is joined to the circumferential perimeter of the first member. In preferred embodiments, the second member is provided either as a radially inside member or a radially outside member to the bulk of the first sealing member. The two members can be bonded together using a mechanical interlocking means with or without an adhesive material or a tie material or member.

In the selected embodiments, the second member is provided in the seal assembly to directly contact at least one of the opposing sealing surfaces. In other embodiments, the second member does not directly contact either of the sealing surfaces but rather is essentially embedded with and bears against the first member of the seal assembly. In yet other embodiments, the second member is substantially embedded within the first member. In this embodiment, the second member can be completely encased within a member of the elastomeric material that forms the first member. The elastomeric member can either be a relatively thin covering overlapping or laminating one or more sides of the second sealing member or a more substantial thicker covering. Still yet in other forms, the elastomeric member substantially encases the second member, yet allowing minimal exposure of the second member, which can be configured to bear against a sealing surface of a component such as a fuel tank.

In alternative embodiments, the second member is formed of a non-compressible material, which exhibits limiting compressibility of the seal assembly under loads at temperatures below the material's softening temperature. The compression-limiting component inhibits over-deformation and/or compression of the elastomeric member. Optimizing the amount and/or degree of deformation of the seal assembly provides optimal sealing ability and increases the durability and effective useful longevity of the seal assemblies in use.

While not necessarily required or desired for all applications, the second member can also maintain the desired overall seal configuration. This configuration typically is the manufactured configuration of the seal assembly and can include a wide variety of geometric shapes including substantially circular, oval, square, rectangular, or polygon shape, all of which can be planar or non-planar. Typically the desired seal configuration is provided to matingly engage the sealing members of the fuel system components and often may exhibit an irregular configuration.

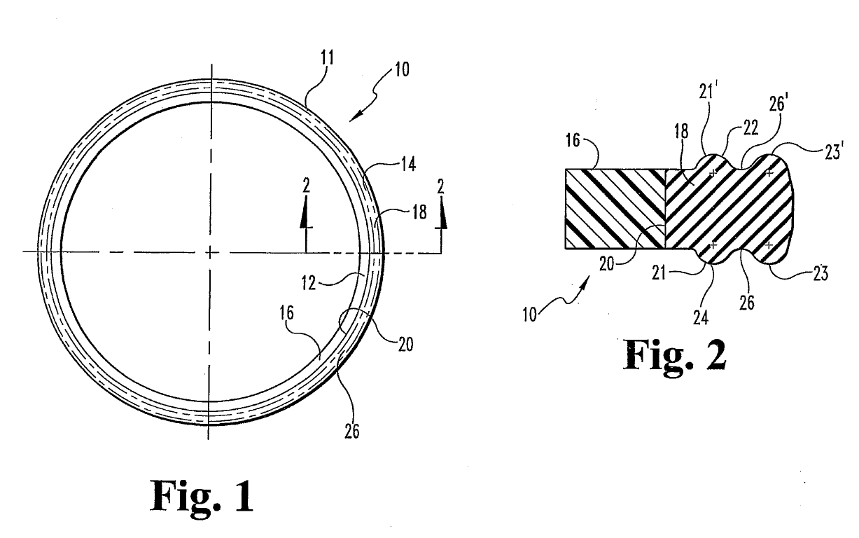

FIGS. 1 and 2 are illustrations of one embodiment of a seal assembly 10 according to the present invention. Seal assembly 10 is illustrated as a substantially circular seal 11 having an inner member 12 and an outer member 14. Inner member 12 is formed of an organic vapor barrier 16, and outer member 14 is formed of an elastomeric material 18. In the illustrated embodiment, inner member 12 is joined to outer member 14 at interface 20. Vapor barrier 16 is provided as a circular ring having a substantially rectangular cross section as illustrated in FIG. 2. Vapor barrier 16 is substantially non-deformable under a compressive load. Furthermore, vapor barrier 16 is formed of a material that is non-reactive or is inert to the organic compositions, particularly fuel compositions.

Outer member 14 includes opposite sealing surfaces 22 and 24. Each surface 22 and 24 includes a double bead configuration including beads 21, 23, 21′ and 23′ defining a recesses 26 and 26′ formed therebetween. Each of recesses 26 and 26′ can be provided as a groove or “V-shaped” depression in the surface 22 and/or surface 24. In one form, the cross section of outer member 14 exhibits generally an “H-shaped” configuration that can be readily visualized in FIG. 2. It will be understood that each surface 22 and 23 independently can include either a single convex portion or protuberance or 3 or more such structures. Further, each of beads 21, 23, 21′ and 23′ can be provided as a projection, ridge, tab, fin, and the like. Double heads 21, 23, 21′ and 23′ extend from surfaces 22 and 24, respectively, in a generally axially direction as defined by circular seal assembly 10.

In preferred embodiments, inner member 18 is formed of an elastomeric material that has a substantially uniform composition throughout. Despite the uniform composition, double beads 21 and 23 (and 21′ and 23′ ) are capable of deforming to a greater extent than the bulk of member 18 under a compressive load.

Outer member 14 can connect to inner member 12 at interface 20 through a wide variety of attachment means. Preferably inner member 12 and outer member 14 are joined via a mechanical interlock connection, which may or may not include an adhesive material and/or a tie member.

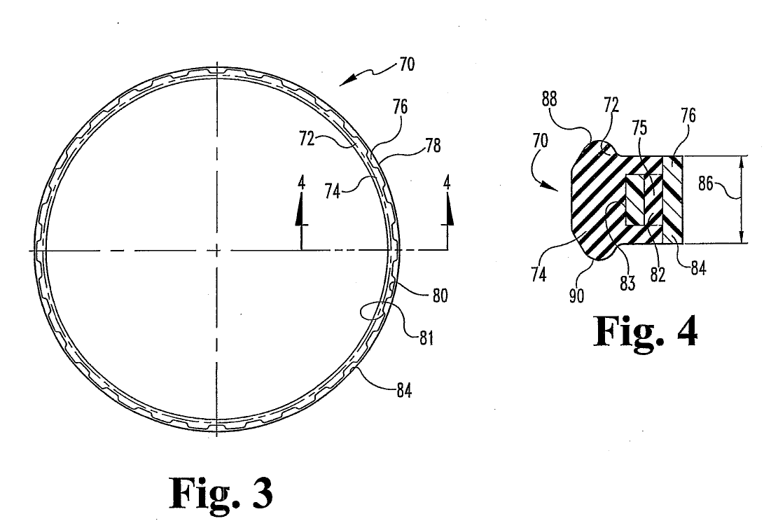

Another embodiment of a seal assembly 70 according to the present invention is illustrated in FIGS. 3 and 4. Seal assembly 70 includes an inner member 72 formed of an elastomeric material 74. Outer member 76 provides a vapor permeation barrier 78. Inner member 72 and outer member 76 connect at interface 80. Preferably interface 80 includes a mechanical interlocking portion 81.

Inner member 72 is adapted to bear against both opposing surfaces of the contaminant or delivery system components; for example, a fuel tank and a fuel sender unit for an automobile or truck. Inner member 72 includes opposite sealing surfaces 88 and 90. Each of sealing surfaces 88 and 90 is illustrated as a single bead or as having a convexly curved protuberance adapted to press against the sealing members or surfaces of the system components.

Since the inner member 72 is formed of an elastomeric material, member 72 can deform under pressure. Preferably the height of outer member 76 measured in the axial direction is selected to limit the compression of the elastomeric material 74 of inner member 72 and/or sealing surfaces 88 and 90. In the illustrated embodiment, the height of outer member 76 is represented by reference line 86. The height can be selected to allow a sufficient compression of the elastomeric material 74 while minimizing the over-deformation of material 74. The combination of inner and outer members 72 and 76 provides a sufficient sealing barrier, preventing escape of liquid and vapor around the seal in use. In preferred embodiments, member 72 can deform by an amount of up to about 25%; more preferably about 15% by volume.

In the illustrated embodiment, inner member 72 and outer member 74 are connected via mechanical interlocking connection 81. Mechanical interlock connection 81 includes a plurality of slots 82 either spaced uniformly or non-uniformly about ring 83 extending radially internal of the inner circumferential perimeter of member 76. In a preferred embodiment, a plurality of slots 82 are spaced from each other uniformly about the outer member 76. More preferably, a plurality of slots 82 are spaced from each other about every 12 degrees. Slots 82 can have a wide variety of internal dimensions. Preferably slot 82 is dimensioned to allow a sufficient amount of an elastomeric material to substantially fill slot 82 to maintain the mechanical connection between inner and outer members 72 and 76, respectively. Preferably slot 82 is provided to have desired width in the radial direction of about 1.0 millimeters and a minimum width of about 5 millimeters. The slot is also provided to have a suitable width in the axial direction. Preferably the maximum width of slot 82 in the axial direction is about 2.5 millimeters while the minimum width is about 1.0 millimeters. In an alternative embodiment, the plurality of slots 82 can be formed as recesses that do not extend completely through member 76.

Outer member 76 also includes an outer peripheral ring 84 that is substantially continuous or imperforate and does not include any recesses, slots, or undulations in or about its periphery. It will be understood that in alternative configurations ring 84 can include additional features including tabs, projections, indents, openings, and/or holes extending either in the radial or axial direction. Further, ring 84 can be circular oval, non-circular, or a polygon structure.

FIG. 5 is a cross-sectional view of another embodiment of a seal assembly 100 provided in accordance with this invention. Assembly 100 includes a first member 102 and a second member 106. Second member 106 includes opposite bearing surfaces 110 and 112. Bearing surfaces 110 and 112 each include a projection 114, 116, respectively. Projections 114 and 116 are deformable projections that can be partially flattened upon sufficient pressure caused by forcing the opposite sealing surfaces together. Second member 106 is preferably formed of a thermoplastic material such as a thermoplastic fluorocarbon. Second member 106 is sufficiently rigid to reinforce seal assembly 100 and/or inhibit over-deformation of member 102.

First member 102 includes opposite sealing surfaces 118 and 120. First member includes a liquid barrier 104. Each of sealing surfaces 118 and 120 includes a double bead construction with a recess 122 or 124 formed between the beads. In this respect, surfaces 118 and 120 can be provided substantially as described for surfaces 22 and 24 of seal assembly 10. Further, first member 102 can be formed of an elastomeric material.

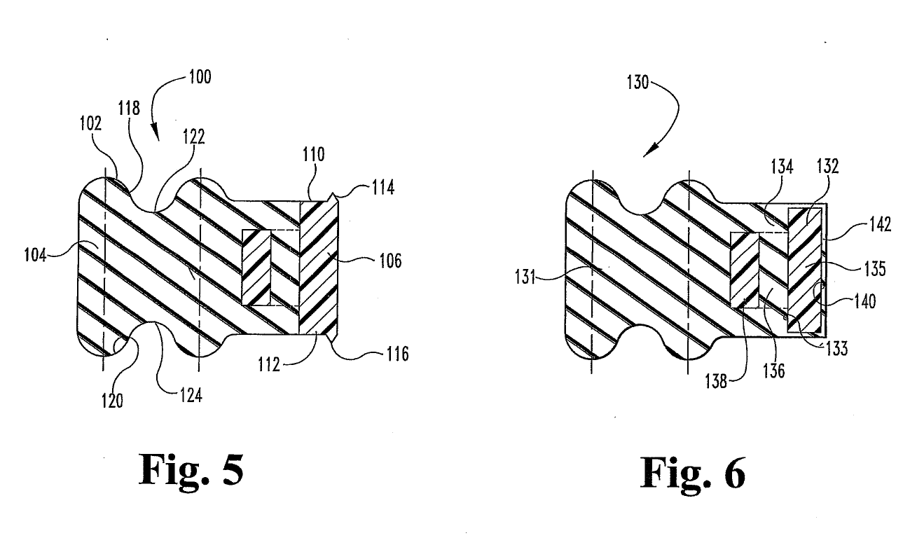

FIG. 6 provides yet another embodiment of a seal assembly 130 according to the present invention. Seal assembly 130 is provided substantially as has been described for seal assembly 100 and includes a first member 131 and a second member 135. In the illustrated embodiment, second member 135 includes a organic vapor barrier 132 that is substantially embedded within an elastomeric material 134. Second member 135 includes a projection 138 extending radially inwardly from the inner peripheral surface 133. Projection 138 is provided with a plurality of slots 136 extending in the axial direction. In the illustrated embodiment, three sides of member 135 including the outer peripheral surface 140 are covered with a relatively thin coating of elastomeric material 142.

In use, the elastomeric material 142 is deformed upon engagement of the opposing sealing surfaces. However, second member 135 provides a compression limiting influence to limit the deformation of the seal assemble 130 and, particularly, the elastomeric portion 134 proximate to member 135. When compressed, second member 135 extends between the opposing sealing members of the fuel system components and provides both a fuel vapor barrier as well as a compression-limiting member for seal assembly 130.

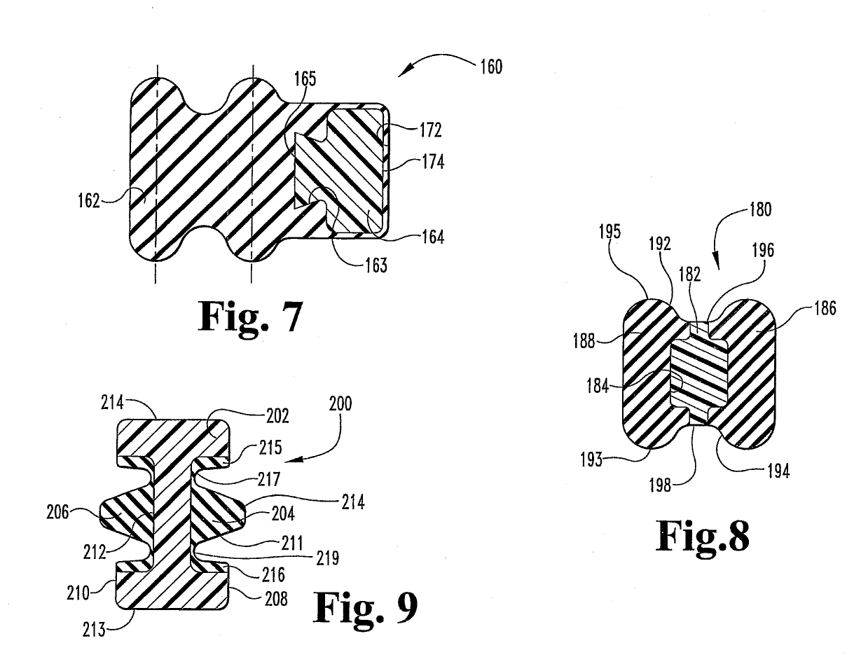

FIG. 7 illustrates yet another embodiment of a seal assembly 160 in accordance with the present invention. Seal assembly 160 includes first member 162, and a second member 164. Second member 164 is substantially embedded within the elastomeric material portion of first member 162.

In the illustrated embodiment, interface 163 between first member 162 and a second member 164 includes an interlocking tenon and mortise joint. It will be understood that an interlocking joint, such as, a dovetail, lock and key, a spline, and/or a finger-joint connection can be used in the present invention. It will also be understood that interface 163 can include additional surface and structured features. For example, interface 163 can comprise a plurality of slots as has been described above for seal assemblies 10 and 70 either in addition to or in alternative to the illustrated connection.

Second member 164 includes a thin member of elastomeric material 172 provided about its external periphery 174 substantially as it has been described for seal assembly 130. Second member 164 also limits compression of seal assembly 160 to inhibit over-deformation, which could degrade the seal assembly and/or allow escape of organic compositions through and around the seal assembly.

FIG. 8 is yet another embodiment of a seal assembly 180 provided in accordance with the present invention. Seal assembly 180 can be viewed as an “H-shaped” (or double beaded) seal. Seal assembly 180 includes a first member 186 and a second member 188. First and second members 186 and 188 are formed of an elastomeric material and may be formed of the elastomer or of different elastomers. In preferred embodiments, first and second members 186 and 188 are formed of the same elastomeric material. Each of first and second members 186 and 188 include sealing surfaces 192 and 194. A pair of protuberances, 193 and 195 extend in radially opposite directions from surface 192 as defined by seal assembly 180. Similarly a pair of protuberances extend in radially opposite directions from surface 194. The two pairs of protuberances can be provided substantially as described for beads 24 and 23 of seal assembly 10.

A third sealing member 182 is positioned between first and second members 186 and 188. Third member 182 provides an embedded vapor barrier to seal assembly 180. The embedded vapor barrier 182 also provides a compression limiting support member for seal 180. Member 182 includes opposite bearing surfaces 196 and 198 to bear against the opposing sealing surfaces. Bearing surfaces 196 and 198 provide an effective seal inhibiting escape of both liquid and/or vapor around and through seal assembly 180. In one preferred embodiment, the third member 182 is formed of a material such as polyphenylsulfide and/or a liquid crystal polymer (LCP). In another embodiment, third member 182 is formed of a material such as a fluorocarbon resin; more preferably a thermoplastic fluorocarbon resin.

FIG. 9 provides still yet another embodiment of a fuel barrier vapor seal assembly 200 according to the present invention. Sealing assembly 200 includes first and second members 204 and 206 formed of an elastomeric material. A third sealing member 202 is formed of a material selected to inhibit organic vapor emission, such as a thermoplastic material or a metallic material such as aluminum, steel, stainless steel, copper, and/or brass. In one embodiment, third member can be provided as an “I-shaped” seal, with the upper and lower cross-members of the I defining the exterior and interior circumferential parameters, respectively, of a round seal assembly. The third sealing member 202 includes a pair of third and fourth bearing surfaces 208 and 210, respectively. Each of bearing surfaces 208 and 210 include a substantially planar portion that is substantially parallel with the other opposite portion of the opposite surface. Further, each surface 208 and 210 includes a groove, channel, or trough 211 and 212, respectively, formed therein. Grooves 211 and 212 provide a receptacle for seating each of first sealing member 204 and second sealing member 206. Third sealing member 202 also includes an inner surface 213 that in use can be exposed to an organic composition. Outer surface 214 of member 202 provides a circumferential exterior barrier for seal assembly 200. Outer surface 214 provides an exterior radial surface that can be exposed to the atmosphere.

First and second sealing members 204 and 206 each include a plurality of projections. In the illustrated embodiment, member 204 includes a first projection 214 centrally located in the axial direction as defined by seal assembly 200. First projection 214 is positioned axially between an upper projection 215 and a lower projection 216 with a pair of recesses, 218 and 219 therebetween. Second member 206 similarly includes three projections defining recesses therebetween.

The fluid sealing member limits compression of the inner surface 213 and acts as a “splash guard” to reduce exposure of the elastomer to the organic composition. The first and second sealing members, 204 and 206, provide the primary liquid sealing function for any organic material that escapes beyond the inner surface 213. The outer surface 214 reduces emission or escape of any organic vapors that have permeated through the first and second sealing numbers 204 and 206.

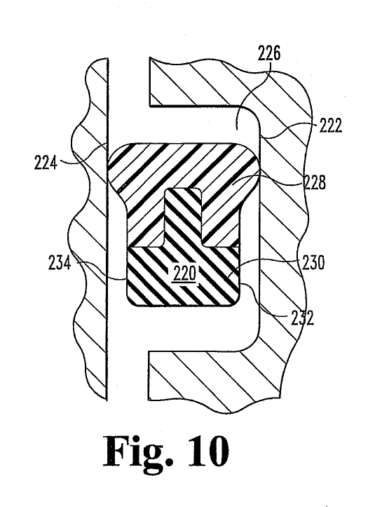

FIG. 10 illustrates one embodiment of a seal assembly 220 positioned between sealing members 222 and 224. Seal assembly 220 is provided substantially as has been described for seal assembly 70. Sealing surface 222 defines recess 226, which is provided to receive a portion of seal assembly 220. Sealing surface 224 is provided as a substantially planar surface. It will be understood that either or both sealing surfaces 222 and 224 can include recessed areas or planar surfaces. In use, sealing surfaces 222 and 224 move in a direction towards each other, usually upon torqing down fasteners such as bolts (not shown) to connect fuel containment or delivery system components together. As the sealing surfaces move toward each other, they compress seal assembly 220 deforming elastomeric portion 228. Eventually sealing surfaces 222 and 224 can engage side portions 232 and 234 of seal portion 230. Seal portion 230 limits further movement of sealing members 222 and 224 towards each other. Consequently, over compression of elastomeric material 228 is inhibited.

The present invention includes various embodiments of seal assemblies 10, 70, 100, 130, 160, 180, and 200 that include a number of structural features. Each seal assembly and structural feature can be formed of different materials. It will be understood that one or more of the structural features and/or materials specifically described for a particular embodiment can be combined with one of the other embodiments disclosed herein.

The present invention also contemplates modifications as would occur to those skilled in the art. It is also contemplated that portions of the seal assemblies embodied in the present invention can be altered, rearranged, substituted, deleted, duplicated, or combined, as would occur to those skilled in the art without departing from the spirit of the present invention. All publications cited in this specification are herein incorporated by reference as if each individual publication was specifically and individually indicated to be incorporated by reference and set forth in its entirety herein.

Further, any theory of operation, proof, or finding stated herein is meant to further enhance understanding of the present invention and is not intended to make the scope of the present invention dependent upon such theory, proof, or finding.

While the invention has been illustrated and described in detail in the drawings and foregoing description, the same is considered to be illustrative and not restrictive in character, it is understood that only the preferred embodiments have been shown and described and that all changes and modifications that come within the spirit of the invention are desired to be protected.

1. A method of reducing emissions of volatile organic compounds from between a first mating component having a first component surface and a second mating component having a second component surface, the method comprising the steps of:
(a) interposing a laminated seal between the first and second sealing member surfaces, the laminated seal having a first seal surface engagable against the first sealing member surface, and a second seal surface, opposite the first seal surface, and engagable against the second sealing member surface, the laminate seal comprising a first layer composed of an elastomeric polymer and a second layer composed of a fluoropolymer resistant to permeation of said compounds, the second layer being joined to the first layer; and
(b) compressing the laminated seal between the first and the second sealing member surface.

2. The method of claim 1 wherein the first layer is composed of a non-fluorinated elastomeric polymer.

3. (canceled)

4. The assembly of claim 1 wherein the first layer is formed of a material selected from the group consisting of: natural rubber, polyisoprene rubber, epoxylated natural rubber, styrene-butadiene rubber, polybutadiene rubber, nitrile-butadiene rubber, hydrogenated nitrile butadiene rubber, hydrogenated styrene-butadiene rubber, ethylene propylene rubber, maleic acid-modified ethylene propylene rubber, butyl rubber, anisobutylene, acryl rubbers, bromide of isobutylene p-methylstyrene copolymer, chloroprene rubber, hydrin rubbers, chlorosulfonated polyethylene, chlorinated polyethylene, maleic acid-modified chlorinated polyethylene, methylvinylsilicone rubber, dimethylsilicone rubber, methylphenylvinylsilicone rubber, polysulfide rubber, vinylidene fluoride rubbers, fluorine-containing vinyl ether rubbers, tetrafluoroethylene-propylene rubbers, fluorine-containing silicone rubbers, fluorine-containing phosphagene rubbers, styrene elastomers, olefin elastomers, polyester elastomers, urethane elastomers, polyamide elastomers and mixtures and blends thereof.

5. The method of claim 1 wherein the seal is provided as a cylindrical or oval ring.

6. The method of claim 1 wherein the seal is provided as a triangle, a square, a rectangle or polygon shaped seal.

7. The method of claim 1 wherein the second layer defines an external circumference of the seal.

8. The method of claim 1 wherein the first layer defines an external circumference of the seal.

9. The method of claim 1 wherein the second layer is rigid.

10. The method of claim 1 wherein the second layer is flexible.

11. The method of claim 1 wherein the second layer member is imperforate.

12-13. (canceled)

14. The method of claim 1 wherein the fluoropolymer is formed of a material selected from the group consisting of: fluorinated ethylene-propylene copolymer, tetrafluoroethylene-perfluoro(propylvinyl ether) copolymer, polychlorotrifluoroethylene, polychlorotrifluoroethylene-tetrafluoroethylene copolymer, polychlorotrifluoroethylene-vinylidene fluoride copolymer, ethylene-chlorotrifluoroethylene copolymer, ethylene-tetrafluoroethylene copolymer, polyvinylidene fluoride, polytetrafluoroethylene, hexafluoropropylene-vinylidene fluoride copolymer, vinylidene fluoride-hexafluoropropylene-tetrafluoroethylene terpolymer, tetrafluoroethylene-hexafluoropropylene-vinylidene fluoride terpolymer and mixtures and blends thereof.

15. The method of claim 1 comprising an adhesive between said first and second layer.

16. The method of claim 1 wherein the second layer member is completely encased by the elastomeric material of the first layer.

17. The method of claim 1 comprising a third layer laminated to either the first layer or the second layer.
